(19) United States
(12) Patent Application Publication
(10) Pub. No.: US 2012/0215391 A1
(43) Pub. Date: Aug. 23, 2012

(54) PROCESSOR-CONTROLLED ACCESS AUTHORIZATION AND BATTERY MANAGEMENT SYSTEM FOR ELECTRIC VEHICLES

(75) Inventors: Tim Schaefer, Niedersachswerfen (DE); Andreas Gutsch, Luedinghausen (DE)

(73) Assignee: Li-Tec Battery GmbH, Kamenz (DE)

(21) Appl. No.: 13/394,276

(22) PCT Filed: Aug. 27, 2010
(86) PCT No.: PCT/EP2010/005291

§ 371 Date: May 8, 2012

(30) Foreign Application Priority Data
Sep. 7, 2009 (DE) 10 2009 040 420.1

(51) Int. Cl. G07C 5/08

(52) U.S. Cl. 701/22

(57) ABSTRACT

In order to control the operation of a vehicle (FZ) comprising an electrochemical energy store (ECS), a mobile control unit (ME) that can be removed from the vehicle is provided for storing and preferably also for processing data, which allows the user of the vehicle to operate the vehicle in a way that is at least also characterized by the data (D) on the operating mode of the electrochemical energy store (ECS) of the vehicle (FZ) stored in a data store (DS) of the control unit.

The present invention concerns a processor-controlled access authorisation and battery management system for electric vehicles, in particular, a method for controlling the operation of a vehicle employing an electrochemical energy storage device, a portable checking device for controlling the operation of a vehicle employing an electrochemical energy storage device, and a vehicle with an electrochemical energy storage device, the operation of which is controlled by means of such a checking device.

The possibilities for the commercial utilisation of electric vehicles depend, in particular in individual forms of public transport, on the achievable range of the vehicles and on the charging periods for the electrochemical energy storage devices used. In this connection deployment of this electrochemical energy storage device that is as optimal as possible is of decisive importance; this is to be achieved by means of an appropriately optimised so-called battery management system. General objectives for such a battery management system are the optimisation of the power output of the systems used, whilst at the same time avoiding or reducing any damaging effects, which can arise, for example, as a result of incorrect charge or discharge currents, or as a result of incorrect temperature management of the systems used.

Thus the service life of an electrochemical energy storage device or the range of an electric vehicle can depend on, amongst other factors, the driving pattern of the user of the vehicle, because, for example, the discharge currents or the operating temperature of an electrochemical energy storage device are functions of the accelerations of the vehicle that is being driven from this energy storage device. In this connection, therefore, a check on access authorisation also becomes more important; this allows stress or damage that has been caused by a user of the vehicle to be assigned to this user.

From the prior art transport systems with battery-operated vehicles are in principle of known art.

Thus DE 38 32 840 A1 describes a transport system with battery-operated vehicles, in which charging points are provided, at which a charge current can be supplied via contacts to the batteries of the vehicles. Both control of the vehicle movement, and also control of the battery charging process, is undertaken with the aid of computers. For this purpose a connecting element and a microcomputer are in each case arranged in the vehicles for the control of the battery charging process.

DE 199 17 817 A1 describes an electronic vehicle monitoring system, which contains a data storage medium in the form of a vehicle key, into which data relevant for the operation of the vehicle can be read in at a data communications station. In the vehicle these vehicle-relevant data are read out from the data storage medium. Vice versa vehicle-relevant data can be read into the data storage medium in the vehicle and after operation of the vehicle is complete can be read out at the data communications station.

DE 10 2004 021 380 A1 describes a device for power supply, which has a plurality of power supply components. The power supply components are in each case provided with a communications interface, and are connected with a common analysis and control unit via this communications interface and a communications channel. The analysis and control unit controls a load management system for the power supply components.

DE 10 2007 018 302 A1 describes a method and a device for the extension of the battery service life by means of adaptive control with the aid of regulators. A method and a system are described for the improvement of the efficiency of a battery-supported energy supply system.

U.S. Pat. No. 5,168,206 describes a battery management chip, which controls the charge and discharge currents of a rechargeable battery. The chip is located in a portable module that is connected with the battery and, with the energy source used to charge the battery.

The object of the present invention is further to improve systems and methods of known art for the processor-controlled battery management system for electrical vehicles.

This is achieved in accordance with the invention by means of the subjects of the independent claims.

In accordance with the invention for controlling the operation of a vehicle employing an electrochemical energy storage device a portable checking device that can be removed from the vehicle is provided for the storage of data, which enables a user of the vehicle to operate the vehicle, and which is provided for the purpose of storing data in a data store concerning the mode of operation of the electrochemical energy storage device of the vehicle.

In the context of the description of the present invention the term “electrochemical energy storage device” should be understood to mean any device that can convert chemical energy directly into electrical energy and can supply an application. This term therefore includes, in particular, galvanic cells or sets comprising a plurality of galvanic cells, but also, for example, fuel cells and other devices for the conversion of chemical energy into electrical energy. In the context of the present invention the electrochemical storage devices include, in particular, rechargeable electrochemical energy storage devices, to which electrical energy can be supplied, and which is then stored as chemical energy in the electrochemical energy storage device. Important examples of such electrochemical energy storage devices are rechargeable galvanic cells, or sets comprising a plurality of such cells.

In the context of the description of the present invention the term “vehicle” should be understood to mean a mobile means of transport, which can serve to provide the transport of goods, tools, or persons. Accordingly this term comprises in particular watercraft, land vehicles, aircraft, spacecraft or combinations of these, such as, for example, amphibious vehicles. In this context an electric vehicle is to be understood as a vehicle with an electric drive. This term comprises in particular electric cars, electric cycles, electric scooters, electric buses, electric trucks, solar vehicles, electric locomotives, in particular therefore, trams, suburban rail systems, underground rail systems, solar-powered vehicles such as solar cars, solar aircraft, electric airships, electric boats, in particular submarines, and special-purpose vehicles such as electric wheelchairs, electric forklift trucks, golf buggies and also in particular, driverless transport vehicles. The term also comprises in particular, hybrid vehicles, fuel cell vehicles, and other electrically driven vehicles.

In the context of the description of the present invention a vehicle that employs an electrochemical energy storage device is to be understood as any vehicle that is equipped with an electrochemical energy storage device. Here this electrochemical energy storage device can serve to provide the drive for the vehicle, can assist the drive, or can serve to provide an energy supply for other functions of the vehicle.

In the context of the description of the present invention a portable checking device for the storage and/or processing of data is to be understood as any device for the storage and/or processing of data, which can be carried by a user, in particular by a human user. This term therefore includes, in particular, chip cards, personal digital assistants (PDAs), notebooks, mobile phones, SIM cards, U-SIM cards and other portable devices for the storage and processing of data.

Advantageous forms of embodiment and further developments are the subjects of the subsidiary claims.

A preferred form of embodiment of the present invention is characterised in that the portable checking device for the storage of data, which can be removed from the vehicle, enables a user of the vehicle to operate the vehicle in a manner that is at least also characterised by data concerning the manner in which the electrochemical energy storage device of the vehicle is operated, which data are stored in a data store of the checking device.

A further preferred form of embodiment of the present invention is characterised in that the vehicle has a drive that at least in part is supplied with energy from the electrochemical energy storage device. In particular this form of embodiment includes hybrid vehicles.

A further preferred form of embodiment of the present invention is characterised in that the vehicle has a drive (EM) that is exclusively supplied with energy from the electrochemical energy storage device. In particular this form of embodiment includes electric vehicles.

A further preferred form of embodiment of the present invention is characterised in that the portable checking device is equipped with means for the storage and processing of data. This form of embodiment enables a particularly effective protection of the data stored on the portable monitoring device against attempts at manipulation by unauthorised persons.

A further preferred form of embodiment of the present invention is characterised in that the data enable a locking or unlocking of the electrochemical energy storage device of the vehicle. This form of embodiment of the invention enables effective and advantageous checking of access authorisation for utilisation of the vehicle thus equipped.

A further preferred form of embodiment of the present invention is characterised in that the data effect control of the power output of the electrochemical energy storage device of the vehicle. This form of embodiment of the invention allows, for example, switchover to a particularly energy-saving mode of operation of the vehicle, or protection of the battery from overload as a result of excessive speeds and the high discharge currents that are linked with these. In this manner the service life of the battery can moreover be increased.

A further preferred form of embodiment of the present invention is characterised in that the data effect control of the power output of the electrochemical energy storage device as a function of the speed of the vehicle. This form of embodiment of the invention is linked with the advantage that effective monitoring of the speed of the vehicle can be implemented in a simple manner.

A further preferred form of embodiment of the present invention is characterised in that the data effect control of the power output of the electrochemical energy storage device as a function of a maximum speed applicable to the vehicle, or a maximum speed to be observed by the user of the vehicle. This form of embodiment of the invention is linked with the advantage that in addition to effective monitoring of the vehicle's speed the observation of speed restrictions is possible in a simple and effective manner.

Some of the forms of embodiment of the present invention described will be combined by the person skilled in the art on the basis of his specialist knowledge; other examples of embodiment, which here or in the following description cannot be definitively described, will be easily discovered by the person skilled in the art with the aid of his specialist knowledge with the aid of the present description.

The invention is not limited to the examples of embodiment here described.

In what follows the invention is described in more detail in terms of preferred examples of embodiment and with the aid of the figures. Here:

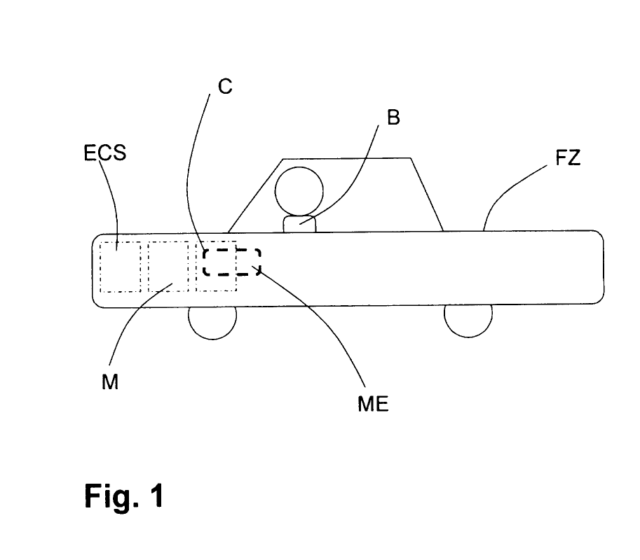

FIG. 1 shows in a schematic manner the basic structure of an inventive vehicle on the basis of a preferred example of embodiment of the present invention;

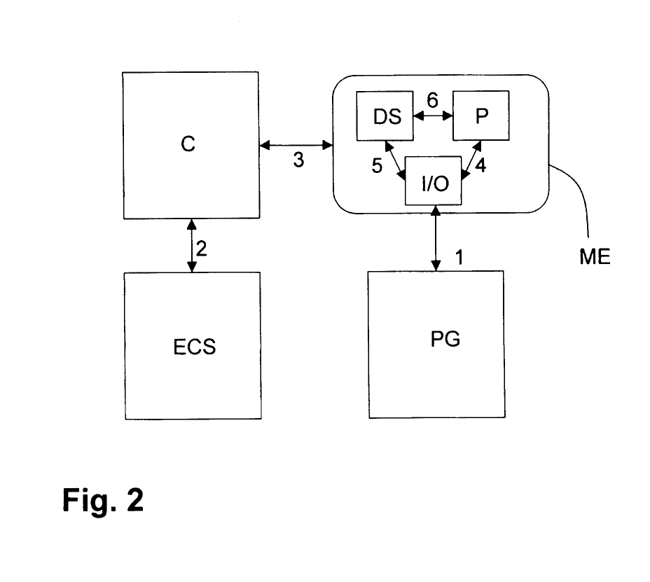

FIG. 2 shows in a schematic manner the basic interaction of various components of an inventive vehicle in conjunction with an inventive method on the basis of a preferred example of embodiment of the present invention;

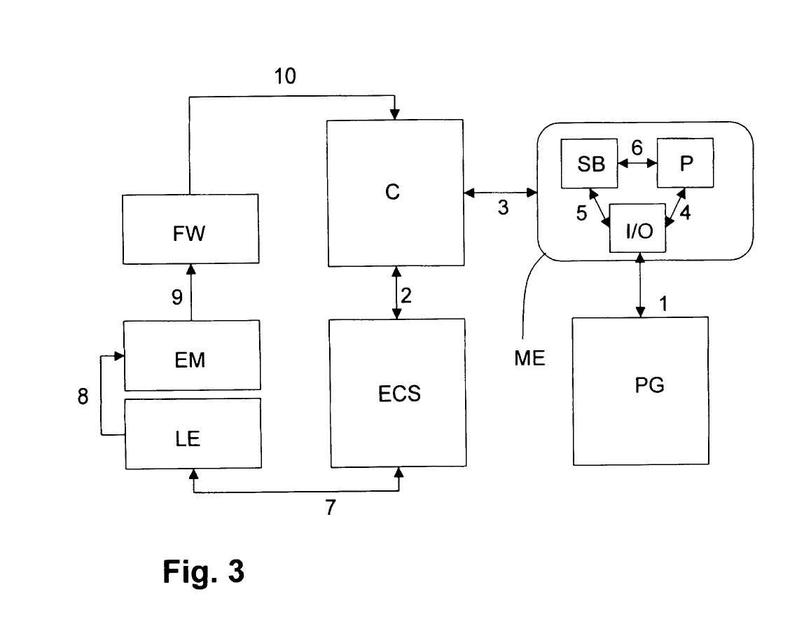

FIG. 3 shows in a schematic manner a further example of embodiment of the present invention; and

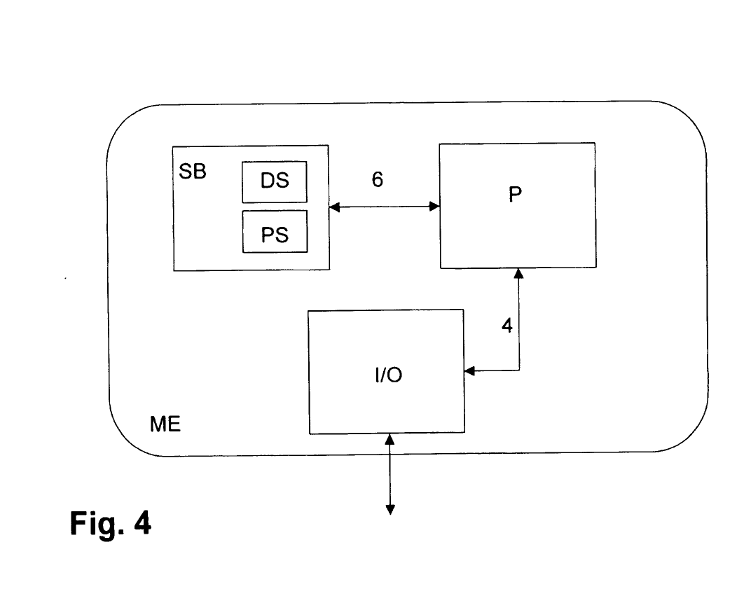

FIG. 4 shows in a schematic manner the structure of an inventive portable checking device for the storage and processing of data on the basis of a preferred example of embodiment of the invention.

As is schematically represented in FIG. 1, the present invention provides a method for controlling the operation of a vehicle FZ employing an electrochemical energy storage device ECS. Here a portable checking device ME for the storage and preferably also for the processing of data, which can be removed from the vehicle, enables a user of the vehicle to operate the vehicle in a manner that is at least also characterised by data D concerning the mode of operation of the electrochemical energy storage device ECS of the vehicle FZ, which data are stored in a data store DS of the checking device.

Here the portable checking device ME is preferably a chip card, which wirelessly or via galvanic connections interacts with a control device C of the vehicle FZ. The control device C is preferably an appropriately modified on-board computer of the vehicle FZ, which employs an appropriate interface for communication with the portable checking device ME and which uses the data D stored on the portable checking device ME to control the operation of the vehicle and the mode of operation of the electrochemical energy storage device.

The control device C is a component of the vehicle's control system, and also controls, amongst other items, the mode of operation of the electrochemical energy storage device and its use in the operation of the vehicle. For this purpose this control device C evaluates data D stored on the portable checking device ME. These data D preferably consist of a plurality of data sets, which comprise data for checking of access authorisation, for regulation of the vehicle drive power level, for battery management of the electrochemical energy storage device and, if necessary, further data for controlling the operation of the vehicle. These data D, and in particular the data sets that they constitute, are preferably stored in a storage region SB of the portable checking device ME. The data are preferably stored in a data store DS of this storage region, which is preferably separated from a program store PS. The control device C accesses these data D via a communications interface I/O of the portable checking device ME. Access to the data is preferably imparted via the processor P of the portable checking device ME.

The data D have preferably been entered with the aid of a programming unit PG into the storage region SB of the portable checking device ME, via a communications interface I/O, before the start of the journey.

Depending on the variant of embodiment of the invention it is, however, also possible that during the journey, or during the operation of the vehicle, data are written from the control device into the data storage regions SB of the portable checking device ME. These data can, for example, take the form of data that concern the mode of operation of the vehicle, in particular the accelerations and speeds incurred, or the power output of the electrochemical energy storage device. On the basis of this data, which can, for example, be read out from the programming unit PG after the journey, the particular mode of operation of the vehicle that was selected by User B can then be determined and reconstituted, so that it is possible to charge the user in a manner that is matched to the vehicle mode of operation actually selected by the user.

The portable checking device ME represented in FIG. 4 in terms of a preferred example of embodiment preferably employs a storage region SB, preferably with a data store DS and a program store PS, and employs a processor P and a data communications interface I/O for the exchange of data, for example, with a programming unit PG for data storage media units of this kind.

As schematically represented in FIG. 4, the access to the storage region is preferably protected through the processor P, with the condition that an exchange of data 6, 4 with the communications interface I/O is only possible via the processor P, in order to secure the data stored on the portable checking device against manipulation.

The data concerning the mode of operation of the electrochemical energy storage device ECS of the vehicle FZ, preferably stored in the data store DS of the storage region SB of the portable checking device ME, are preferably used to control the charge and/or discharge currents of the electrochemical energy storage device ECS such that the drive unit M behaves as required for the operation of the vehicle as characterised by the stored data D.

As is schematically represented in FIG. 2, for this purpose the control device C of the vehicle FZ preferably communicates via an appropriate data link 2 with the electrochemical energy storage device ECS, in which the power electronics required for implementation of the control commands are preferably integrated. The control device C exchanges data 3 with the portable checking device ME. Also this exchange of data avoids, in an advantageous and preferable manner, any direct access of the control device to the storage regions DS and/or PS; instead it exchanges data with the portable checking device, with the aid of the processor P, preferably integrated in the portable checking device ME, to support and ensure protection of the data against manipulation.

Any direct exchange 5 of data between the communications interface I/O of the portable checking device ME and the data store DS should preferably only take place by exception, and should be restricted to privileged users of the portable checking device, such as, for example, the card manufacturer or the card issuer.

An inventive portable checking device ME can, for example, be implemented with the non-contacting storage chip of the type SRT512 from the manufacturer ST Microelectronics. This module takes the form of a short-range non-contacting storage chip operating at 13.56 MHz with a 512-bit EEPROM and anti-collision functions. The SRT512 has been conceived in particular for applications with short transmission distances, for example in accordance with ISO 14 443-B, which require re-useable tokens, as, for example, in applications in which access is checked, or when checking tickets for events, or tickets used on forms of public transport. This module employs an in-built anti-collision mechanism for avoiding conflicts with adjacent cards and achieves the transaction speeds required for these applications. In this module computing functions are integrated, including functions with two counters, and a so-called anti-tear functionality.

In conjunction with the implementation of the present invention the non-contacting smart card of the type ST19WR from ST Microelectronics can also, for example, be introduced, which has already been widely disseminated as a credit card. This module combines a high data throughput and correspondingly high transaction speeds with a high level of security against attack and counterfeiting. In a similar manner other non-contacting or contacting products such as, for example, so-called RFID chips, or other non-contacting smart cards can be introduced.

Chip cards, often also designated as smartcards or smart cards, or integrated circuit cards (ICC), are special plastic cards with an in-built integrated circuit (chip), which contains hardware logic, storage, or even a microprocessor. Chip cards can be differentiated according to various criteria. The most intuitive form of differentiation is that between storage chip cards with simple logic, and processor chip cards with their own card operating systems and cryptographic capabilities.

Chip cards are also differentiated by means of their interface with the environment. Here the non-contacting chip cards are segregated from the contacting cards. The heart of a chip card is the integrated circuit (chip), which determines the capabilities of the chip card and thus its field of application. The chip is often protected by the chip card module, such that the chip is normally completely imbedded and invisible. The module also represents the link to the outside world.

The simple storage chip cards consist only of a store, from which data can be read out, or to which data can be written. Via the interface it s possible, for example, to access sequentially the individual storage cells.

Storage cards are preferably used in applications concerned only with the storage of data, but not the conduct of complex processes. Depending upon the chip that is used the data can be protected by means of PINs or passwords from being read out or modified by a third party.

Processor chip cards employ a microprocessor, via which the stored data can be accessed. In processor chip cards there is often no possibility of accessing the data region directly. The detour via the microprocessor allows the data on the card to be protected from alien access via cryptographic methods. The appropriate cryptographic algorithms preferably run as corresponding programs on the processor.

Here cryptographic methods can preferably be deployed on the basis of so-called “public key cryptography”. Here a pair of matched keys are introduced. One of these is a public key, which—in the case of an encryption method—is used to encrypt information for the key owner. The other is a private key that must be kept secret by the key owner and is introduced for purposes of de-encryption. Such a system is designated as asymmetric, since different keys are used for encryption and de-encryption.

With this method only a single key pair is required for each participant, since the possession of the public key does not compromise the security of the private key. Such a system can also be used to generate a digital signature. The digital signature is calculated from the data to be signed or their hash value and the private key. The correctness of the signature—and thus the integrity and authenticity of the data—can be checked by means of appropriate operations with the public key. Public key methods can also be used for purposes of authentication in an interactive communication and thus for checking access authorisation in the context of the present invention.

The possibility of allowing application-specific programs to run on these microprocessors offers many advantages in comparison to storage cards, e.g. in cards that are used as means of payment (cash cards) or hold important data (e.g. SIM cards for mobile phones). Often the card also holds a signed key and serves as a decoder card (such as e.g. for pay-per-view television or other systems in which access is checked). Parts of the card operating system (COS) and the intended applications can even be loaded onto the card in the course of manufacture of the chips.

In particular smart cards can serve as secure storage for information or keys. They can, however, also be utilised for the implementation of various security services, such as, for example, authentication, encryption, or a signature. Private keys are often thereby stored on the smart card. Since these secret keys are protected against unauthorised read-out, no attempt to interrogate the key is possible.

Modules of this kind are also suitable for controlling the access to pre-paid electric vehicles, wherein this advantageously occurs with one form of embodiment of the present invention, in which the data D stored on the portable checking device ME enable the locking or unlocking of the electrochemical energy storage device of the vehicle. In principle this takes place using conventional electronic access authorisation identification methods, with the condition that locking or unlocking of the electrochemical energy storage device of the vehicle is preferably undertaken, linked with a particularly effective check of access authorisation. Here the locking or unlocking is preferably undertaken in a manner such that the control device C of the vehicle, for example, the latter's so-called on-board computer, checks the authorisation of a user B with the aid of data stored on the portable checking device ME used by him, and in the event of a positive result for this check unlocks the electrochemical energy storage device.

The checking of access authorisation can advantageously be implemented in the context of the present invention in accordance with the example of electronic wallets. These electronic wallets enable the cashless offline payment of small amounts of money—with or without the input of a PIN—preferably by means of chip cards. An electronic wallet frequently operates in accordance with the pre-payment (pay before) mode.

Firstly it is charged up with an amount of money at a charging terminal. Only then can cashless payments be made by using payment terminals. Charged amounts are often ascribed to a pool account—payment amounts are then taken from the pool account. However, in the case of electronic wallets that are managed on the basis of credit, this is only possible if credit is available, otherwise they must first be recharged. Smaller amounts in particular can thus be paid quickly without any difficulty, without the need for each acceptance point to be continuously networked.

Effective checking of access authorisation can advantageously take place on the basis of an authentication. In an authentication event between two subjects the “authenticant”—in accordance with the current use of language—“provides evidence for his authentication”, while the “authenticator” “authenticates” the “authenticant”.

The authentication is a verification of the claim of authenticity. Often the authentication of a user is thereby used as an identification of this user.

In the example of a computer program that can grant access to a secured region, the user first claims his identity, in that he enters a user name. In addition he provides evidence for his authentication, in that he enters his password. The program can identify the user on the basis of these data and thereupon authenticates his identity. The password, which only the correct user can have entered, verifies that he is actually the user that he claims to be. Thus the identity of the communications partner is established for the program. Whether the authenticated user may be granted access, is decided by the program within the context of the authorisation. If this is also successful, the program grants to the user access to the secured region.

Encryption methods can also advantageously be introduced for purposes of authentication, such as for example public key methods, or the algorithms familiar from SIM cards. Here the authenticant signs in, for example, a random number previously unknown to him, transmitted to him by the authenticator, in that he encrypts this with the secret key of the user and transmits the signed-in random number back to the authenticator. The authenticator de-encrypts this information with the public key of the user. If the original random number is restored, this substantiates the fact that this random number has been encrypted by the authenticant with the secret key of the user; this authenticant therefore must be or must have been in possession of this secret key of the user. The random number, encrypted using the secret key of the user, then serves, so to speak, as a token for the execution of an access authorisation check.

The unlocking that takes place after a successful check of access authorisation can thereby take place in a time-controlled manner, once again by means of data D stored on the portable checking device ME, defining a utilisation time for the user, so that on expiry of the maximum utilisation time characterised by the data stored on the portable checking device the electrochemical energy storage device is locked.

In addition to the creation of secured access for electric vehicles by means of the locking and/or unlocking of a battery with the aid of a token acting as an immobiliser, the present invention in some forms of embodiment can also be used to control the power output of the electrochemical energy storage device of the vehicle. Provided that the data D stored on the portable checking device, are actually suitable in terms of their content for controlling the power output of the electrochemical energy storage device of the vehicle, it is possible with the aid of the inventive portable checking device to check the authorisation of a user for use of a high power mode of operation (“power mode”), and it is thus further possible to check whether the user of the portable checking device is only authorised to use an energy-saving mode (“eco-mode”).

In order to control the power output of an electrochemical energy storage device appropriately it is necessary that the data stored on the portable checking device ME take account of the electrochemical characteristics of the energy storage device that is being used. Different electrochemical energy storage devices must, by virtue of their different technologies, in each case have matched charge methods and discharge methods. Here maximum current and voltage values are normally prescribed as functions of time.

In particular, traction batteries, that is to say electrochemical energy storage devices that are used to drive electric vehicles, must be protected from so-called “deep discharge”. Such protection against deep discharge requires that the current driving the vehicle is automatically limited. The vehicle can then still be operated at a reduced power and by means of a special (kick-down) device the limit on the current can be rescinded in hazardous situations.

In particular, traction batteries should as far as possible be operated within their optimal temperature range. Also, for purposes of estimating the residual range of an electric vehicle operated with an electrochemical energy storage device, and also for purposes of determining the energy available for accelerating the vehicle, or the possible assimilation of braking energy that is to be stored chemically, knowledge of the internal state of the battery that is as accurate as possible is required, or at least advantageous. The internal state of an electrochemical energy storage device can thereby be comprehended in physical terms as an aggregation of condition factors; this comprises condition factors such as, for example, temperature, the age of the energy storage device, the number of cycles, the internal resistance, the state of charge, and similar condition factors.

For purposes of controlling peak loads double-layer capacitors are also particularly suitable as electrochemical energy storage devices; their deployment is in particular advantageous if large power levels must be stored or made available over short periods of time. For an appropriately equipped vehicle this means that peak loads on the vehicle drive are provided as far as possible from the double-layer capacitor, while in contrast the low average loads are preferably taken from a galvanic battery.

With the aid of such double-layer capacitors, it is possible to increase significantly the available capacity of a battery in an electric vehicle, in particular, if a conventional galvanic battery is used in conjunction with a double-layer capacitor. In the context of one example of embodiment of the present invention provision is made to make the deployment of such double layer-capacitors or other units increasing the power output of the vehicle dependent on an authorisation of the user; this preferably ensues from data stored on the portable checking device ME and is checked by a control device C of the vehicle.

These descriptions are designed to make clear by example that different modes of operation of an electrochemical energy storage device in a vehicle thus equipped are associated with different costs as a function of the loads associated with the particular mode of operation selected by the user. With the present invention, it is now possible to limit the modes of operation of the vehicle available to a user in accordance with the tariff that he has selected and the payment linked with that, or to provide access to particular modes of operation. For this purpose it is simply required that appropriate data are stored on the portable checking device that the user carries with him, and which he uses together with the electric vehicle; these data identify the user as being authorised with regard to the electric vehicle, in particular, with regard to its control device C, to use the corresponding modes of operation.

The present invention is suitable in an advantageous manner for applications in which access, preferably pre-paid access, to an electric vehicle is to be provided to a user, and in which preferably also the authorisation is to be checked, as to whether this user may use the eco-mode, or the power mode, or both modes, or also other modes of operation of the electric vehicle. The invention is particularly suitable for purposes of providing secured access for electric vehicles, wherein it is preferred that access security is implemented in terms of locking the battery with the aid of a so-called token, so that at the same time a form of immobilisation is implemented, so that other forms of security, such as, for example, steering wheel locks or bicycle locks, can be dispensed with. In an advantageous manner the invention is thereby implemented with the aid of chip cards and on the basis of credit.

Other examples of embodiment of the invention envisage in particular detection of current traffic speed restrictions, for example by means of specially equipped cameras or other sensors, and preferably with the output of a warning to the driver. In particular districts, for example in the inner city or at construction sites, at which particular speed restrictions are provided, in accordance with some examples of embodiment of the invention an automatic switchover to a particular mode of operation of the vehicle, such as for example the eco-mode, can be provided by an automatic detection of the speed restriction there prescribed. In this manner it is possible to combine protection of the electrochemical energy storage device (battery), and/or an increase of the service life of the electrochemical energy storage device, with the observance of prescribed speed restrictions.

In this regard examples of embodiment of the invention are provided, in which depending upon the tariff paid, the vehicle can only be operated in particular modes of operation, that is to say, for example, only in the eco-mode or in modes of operation that have been graded in terms of power output. In some examples of embodiment of the invention the checking of access authorisation is implemented with the aid of a token, which, for example, can be embodied as a so-called RFID chip, and which communicates with the battery management system and thereby, amongst other functions, undertakes the release of load algorithms in the battery system, which serve to release particular levels of power output when the vehicle is in operation.

In particular in such examples of embodiment of the present invention, in which appropriate portable devices, such as e.g. chip cards, are used, an ignition lock is no longer required as a means of checking access authorisation. The electronic authorisation identification (token) also activates or deactivates the battery management system, which in the event of longer periods of inactivity of the electric vehicle—as a function of the type of battery—preferably executes an equalisation cycle, in order that the available energy stored in the electrochemical energy storage device is distributed as well as possible and thus the electrochemical energy storage device remains as ready as possible to provide power output.

Since electric vehicles, in particular on short journeys, are subject to high accelerations, it is important not only for the protection of the electrochemical energy storage device, but also for the occupants of the vehicle under certain circumstances, to protect the user of the vehicle from transgression of speed restrictions, in order on the one hand, to increase the safety of travel and on the other hand, to lengthen the battery service life. This preferably takes place in that current speed restrictions are registered, preferably visually in real time on the windscreen, and in that the signal thereby generated is transmitted to the battery management system of the battery or the energy management system of the electrochemical energy storage device, and in that the eco-mode or another operating mode is there activated, in which the current flow is reduced and the acceleration is limited. The braking energy is also preferably stored (recuperated) in the electrochemical energy storage device.

in a further example of embodiment of the invention provision is made that the control device C of the vehicle is coupled to a linked navigation unit, such that in play streets or town centres, for example, a zone is permanently identified with a speed restriction of, for example, 30 km/h, and the electric vehicle is controlled via the energy management system or the battery management system such that the driver cannot travel any faster at such locations.

FIG. 1 shows in a schematic manner the basic structure of an inventive vehicle on the basis of a preferred example of embodiment of the present invention. A user B gains access to a vehicle FZ, in that he brings a portable checking device ME, preferably a chip card, for example, a SIM card or a USIM card of a mobile wireless network operator, a personal digital assistant, a notebook, a mobile phone, or a similar device acting as an electronic means of authorisation identification, into a galvanic or non-contacting connection enabling data communication with a control device C of the vehicle FZ, wherein data D are stored on this portable checking device ME, which contain information concerning the mode of operation of the electrochemical energy storage device of the vehicle FZ. With the aid of this data D the control device C controls the operation of the vehicle by governing the mode of operation of the electrochemical energy storage device ECS of the vehicle FZ, which, for example, drives the motor M of the vehicle.

FIG. 2 shows in a schematic manner the basic interaction of various components of an inventive vehicle in the context of an inventive method on the basis of a preferred example of embodiment of the present invention; Data D concerning the mode of operation of the electrochemical energy storage device ECS of the vehicle FZ are written from a programming unit PG into a data store DS of the portable checking device ME. Here the data flow 1, 4, 6 via the preferably bi-directional communications interface I/O of the portable checking device ME from a programming unit PG via the communications interface I/O into the data store DS of the portable checking device. For security reasons this occurs with the aid of a processor P, without which no access can preferably be made to the data store DS.

A control device C of the vehicle reads 3—and preferably also writes—data into the data store DS of the portable checking device, wherein these processes again preferably take place mediated exclusively through the processor P, without which no access can preferably be made to the data store DS. The control device C then governs 2 the mode of operation of the electrochemical energy storage device ECS and thus the operation of the vehicle FZ, which is preferably driven by means of this electrochemical energy storage device ECS. Insofar as the control device C writes data into the data store DS of the portable checking device ME, these data preferably take the form of data that serve to provide the power-dependent levying of charges onto the user as a function of the mode of operation of the vehicle FZ selected by the user of the vehicle.

FIG. 3 shows in a schematic manner a further example of embodiment of the present invention. The control device C of the vehicle FZ receives 10 from the chassis FW or from sensors fitted to the vehicle FZ, such as cameras or similar equipment, signals from which the actual speed of the vehicle and/or the permissible maximum speed of the vehicle can be determined. As a function of these signals 10 and as a function of the data D that are stored on the portable checking device ME, the control device C governs the mode of operation of the electrochemical energy storage device, that is to say, for example, the maximum power output or other operating parameters and thus the mode of operation of the vehicle, for example, its speed or its available maximum speed, depending upon the form of embodiment of the invention.

The control device communicates 2 with the electrochemical energy storage device ECS and the latter supplies 7 the outputted power 8 via the power electronics LE to the electric motor EM. The electric motor 9 drives the chassis FW with this power.

In the context of the description of the present invention on the basis of the figures the following reference symbols have been used:
ECS electrochemical energy storage device
M motor
C control device, on-board computer
ME portable checking device, chip card
B user of the vehicle
FZ vehicle
PG programming unit
I/O communications interface
P processor
DS data store
SB storage region
PS program store
LE power electronics
EM electric motor
FW chassis
1-10 data communications, data flow

1. A method for controlling operation of a vehicle employing an electrochemical energy storage device, wherein a portable checking device, which can be removed from the vehicle, enables a user of the vehicle to operate the vehicle, and a control device is provided to store data, concerning a mode of operation of the electrochemical energy storage device of the vehicle, in a data store.

2. The method in accordance with claim 1, wherein the portable checking device that stores data, which can be removed from the vehicle, enables a user of the vehicle to operate the vehicle in a manner that is at least also characterised by the data, concerning the mode of operation of the electrochemical energy storage device of the vehicle, which data are stored in a data store of the control device.

3. The method in accordance with claim 1, wherein the vehicle has a drive that at least in part is supplied with energy from the electrochemical energy storage device.

4. The method in accordance with claim 1, wherein the vehicle has a drive that is exclusively supplied with energy from the electrochemical energy storage device.

5. The method in accordance with claim 1, wherein the data enable a locking or unlocking of the electrochemical energy storage device of the vehicle.

6. The method in accordance with claim 1, wherein the data effect control of power output of the electrochemical energy storage device of the vehicle.

7. The method in accordance with claim 6, wherein the data effect control of the power output of the electrochemical energy storage device as a function of a speed of the vehicle.

8. The method in accordance with claim 7, wherein the data effect control of the power output of the electrochemical energy storage device as a function of a maximum speed applicable to the vehicle, or a maximum speed to be observed by the user of the vehicle.

9. A portable checking device for controlling an operation of a vehicle employing an electrochemical energy storage device, wherein the checking device can be removed from the vehicle, enables a user of the vehicle to operate the vehicle, and has means for storage of data, and
wherein the checking device is provided to store data, concerning a mode of operation of the electrochemical energy storage device of the vehicle, in a data store.

10. The checking device in accordance with claim 9, wherein the checking device is designed to execute a method for controlling the operation of a vehicle employing an electrochemical energy storage device.

11. The checking device in accordance with claim 9, wherein the checking device includes means for storing and processing data.

12. A vehicle with an electrochemical energy storage device, operation of which is controlled by a portable checking device, wherein the checking device is designed in accordance with the checking device of claim 9.

13. The vehicle in accordance with claim 12, wherein the vehicle includes a drive that at least in part is supplied with energy from the electrochemical energy storage device.

14. The vehicle in accordance with claim 13, wherein the vehicle includes a drive that is exclusively supplied with energy from the electrochemical energy storage device.
